(19) United States
(12) Patent Application Publication
(10) Pub. No.: US 2003/0221041 A1
(43) Pub. Date: Nov. 27, 2003

(54) Sensor with switched fabric interface

(75) Inventor: Cory M. Watkins, Chanhassen, MN (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(73) Assignee: August Technology Corp.

(21) Appl. No.: 10/423,470

(22) Filed: Apr. 25, 2003

Related U.S. Application Data
(60) Provisional application No. 60/375,319, filed on Apr. 25, 2002.
(60) Provisional application No. 60/375,528, filed on Apr. 25, 2002.

(51) Int. Cl. G06F 13/00

(52) U.S. Cl. 710/316; 709/253

(57) ABSTRACT

A sensor, camera or imager with on-chip switched fabric interface where in varying embodiments the fabric interface may be one of InfiniBand, StarFabric, or PCI Express.

### CROSS-REFERENCE TO RELATED APPLICATIONS

This application cross references and incorporates by reference U.S. Provisional Patent Application Nos. 60/375,528 and 60/375,319 both filed on Apr. 25, 2002.

### BACKGROUND OF THE INVENTION

1. Technical Field

The present invention relates to methods and devices for acquiring and processing data from high speed digital sensors such as CMOS sensors, cameras or the like.

2. Background Information

Currently, there are various methods for acquiring and processing data from high speed digital cameras. In a typical scenario, the digital camera sends data across a digital serial or parallel bus (such as Camera Link, USB, or Firewire) to a single computer for processing. In certain applications, this scenario is sufficient such as in scenarios at speeds up to 50 MB/sec.

Often to compensate for the short comings of these current systems, and depending on the processing complexity, the overall data processing system or computer may employ one or more processors for processing the data.

As the camera data rates continue to grow and improve at rates far exceeding the data processing rates of processors, it is necessary to develop alternative methods for acquiring, distributing, and processing data from high speed cameras.

### SUMMARY OF THE INVENTION

The present invention is a sensor with integrated switched fabric interface where in varying embodiments the fabric interface may be one of InfiniBand, StarFabric, or PCI Express or the like.

### BRIEF DESCRIPTION OF THE DRAWINGS

Preferred embodiment of the invention, illustrative of the best mode in which applicant has contemplated applying the principles, are set forth in the following description and are shown in the drawings and are particularly and distinctly pointed out and set forth in the appended claims.

FIG. 1 is one embodiment of the present invention in CMOS Sensor Die form with the switched fabric network on-chip of the sensor; and

FIG. 2 is another embodiment of the present invention in a camera form.

### DETAILED DESCRIPTION OF THE PREFERRED EMBODIMENT

Camera sensors are at present or soon to be capable of data rates of 500-1000 MB/second and faster. The novel approach and device of the current invention functions with such high speeds and flexibility, camera sensors do not bottleneck the data transmission mechanism between processing devices.

The novel approach is a sensor that employs a switched fabric network interface integrated with the sensor. In the first embodiment of the invention, the switched fabric network interface is on-chip for a one chip complete solution. In another version, the switched fabric network interface is integrated with the sensor. In a similar version, the switched fabric network interface is external of the sensor such as that of a separate chip on a circuit board. This eliminates any performance issues that occur from transferring the data from the camera to the processor, and allows for distributed data processing in real time.

A switched fabric network is a network between two or more devices. The fabric enables direct private transfer of data over one or more virtual lanes that are defined between any two or more devices. Furthermore, a switched fabric network allows remote direct memory access between devices. Thereby, only one device need manage the transaction.

The switched fabric network in this novel approach for overcoming the data transferring and processing limitations may be any device capable of performing the functions of a switched fabric network and may be one of the following: InfiniBand, StarFabric, PCI Express, or the like.

In this embodiment, the switched fabric network interface is built directly on or into the sensor. In one version, the switched fabric network interface is on the sensor, and thus an integrated circuit having both the sensor and the switch fabric network interface thereon.

In more detail, the sensor includes a switched fabric interface integrated on the sensor circuit board or otherwise within the sensor. The sensor via the switched fabric interface is linked to one or more computers or devices and corresponding fabric interface adapters in the computers or other devices. This enables the following advantages: (1) greater than 1 GB/second data transfer rates, (2) enables efficient data division of data to one or more computers or devices, (3) reduces the operating system overhead, and (4) reduces cost over proprietary solutions by using industry standard interfaces.

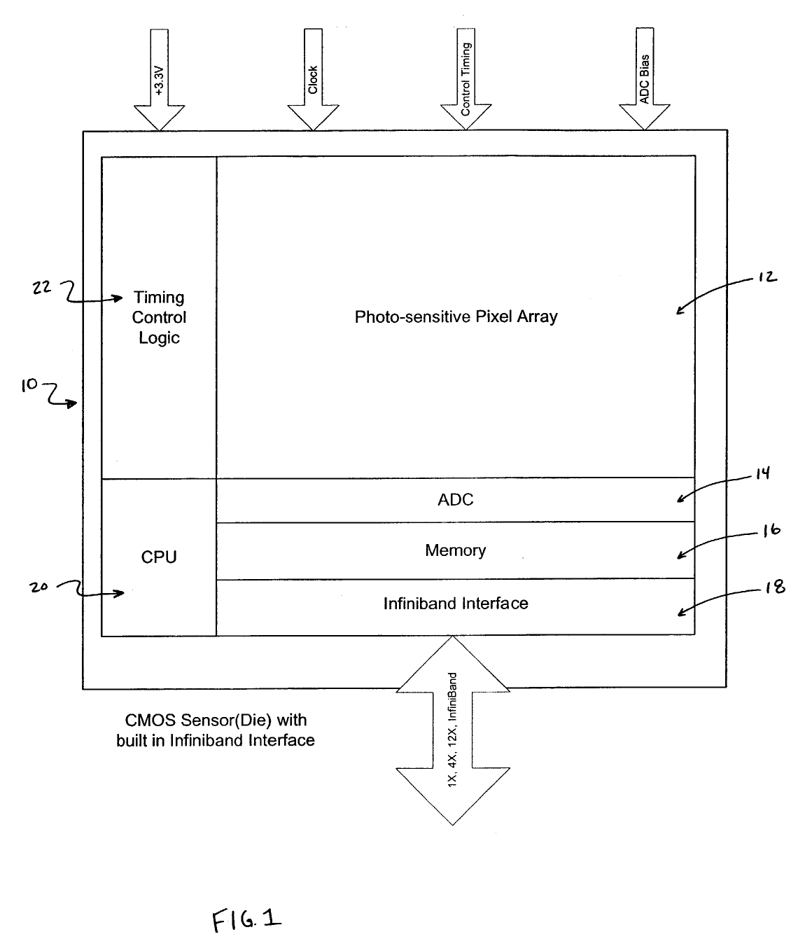

The invention is such that it encompasses any embodiment in which the switched fabric interface is integrated on or in the silicon with the camera sensor. In this particular case that is shown in FIG. 1 as one example of the present invention, an InfiniBand interface is integrated within the die to a CMOS image sensor.

In this embodiment as shown in FIG. 1 which is one example of the present invention, the novel CMOS sensor 10 is one chip with a photo sensitive pixel array 12, optional ADC 14, memory 16, a switched fabric network interface 18 such as an InfiniBand interface, a CPU 20, and a timing logic control 22. These devices are all part of a single chip. Various possible inputs and outputs therefrom are also shown.

It is contemplated as part of the invention that the sensor may be a camera, CMOS image sensor, or any other imaging sensor.

The integrated nature of the sensor and switch fabric network allows for a system where one or multiple computers may be used to process the data while the sensor with its integrated switch fabric network directs the data rather than one or more of the computers. This allows for significantly more rapid data rates since the data rate of the sensor and switched fabric network far exceeds the data rate of the parallel or serial bus and the computer(s) connected thereto.

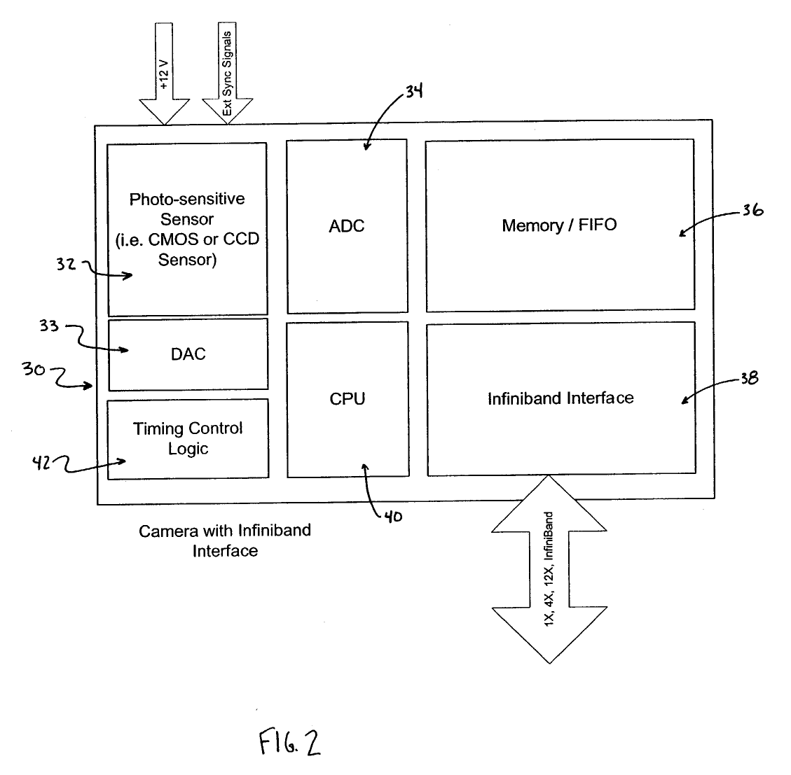

In yet another embodiment, the camera would have a switched fabric interface and would be linked to one or more computers via a fabric switch and corresponding fabric interface adapters in the computers. In this case, one version is where the switched fabric network interface is part of a multiple chip system such as on a PCB board as is shown in FIG. 2. In another version, the switched fabric network interface and sensor are interconnected using a common interface.

In this embodiment as shown in FIG. 2 which is one example of the present invention, the camera 30 is multiple interconnected chips with a photo sensitive pixel array 32 such as a CMOS or CCD sensor, a DAC 33, optional ADC 34, memory 36 or FIFO, a switched fabric network interface 38 such as an InfiniBand interface, a CPU 40, and a timing logic control 42. These devices are all part of a single camera. Various possible inputs and outputs therefrom are also shown.

In either embodiment, this switched fabric interface with any of the sensor, CMOS image sensor, camera sensor or camera may be used single source to single destination, or using the intelligence and speed to the switch fabric interface may be used to direct data to multiple destinations in a random or patterned manner such as ping ponging (first image to a first computer, second image to a second computer, third image to the first computer and so forth).

Accordingly, the invention as described above and understood by one of skill in the art is simplified, provides an effective, safe, inexpensive, and efficient device, system and process which achieves all the enumerated objectives, provides for eliminating difficulties encountered with prior devices, systems and processes, and solves problems and obtains new results in the art.

In the foregoing description, certain terms have been used for brevity, clearness and understanding; but no unnecessary limitations are to be implied therefrom beyond the requirement of the prior art, because such terms are used for descriptive purposes and are intended to be broadly construed.

Moreover, the invention's description and illustration is by way of example, and the invention's scope is not limited to the exact details shown or described.

Having now described the features, discoveries and principles of the invention, the manner in which it is constructed and used, the characteristics of the construction, and the advantageous, new and useful results obtained; the new and useful structures, devices, elements, arrangements, parts and combinations, are set forth in the appended claims.

What is claimed is:

1. A sensor with a switched fabric interface incorporated therein.

2. The sensor of claim 1 wherein the switched fabric interface is on-chip with the sensor.

3. The sensor of claim 2 wherein the fabric interface is one of the group of InfiniBand, Star Fabric, and PCI Express.

4. The sensor of claim 2 wherein the sensor is one of the group of a CMOS sensor, image sensing device, charged coupled device array (CCD), and a photo sensitive pixel array.

5. An image sensor with a switched fabric interface incorporated therein.

6. The image sensor of claim 5 wherein the switched fabric interface is on-chip with the sensor.

7. The image sensor of claim 6 wherein the fabric interface is one of the group of InfiniBand, Star Fabric, and PCI Express.

8. A camera with a switched fabric interface for transferring data to one or more devices.

9. The camera of claim 8 wherein the fabric interface is one of the group of Infiniband, Star Fabric and PCI Express.

10. An photo sensitive device with a switched fabric interface for transferring data to one or more devices.

11. The photo sensitive device of claim 10 wherein the fabric interface is one of the group of Infiniband, Star Fabric, and PCI Express.

12. A method of transferring data, the method including sensing data via a sensor with a switched fabric interface incorporated therein, and transferring the data to one or more devices connected on the switched fabric network.

13. The method of claim 12 wherein the fabric interface is one of the group of Infiniband, Star Fabric, and PCI Express.

14. A method of transferring data, the method including imaging data via a camera with a switched fabric interface incorporated therein, and transferring the data to one or more devices connected on the switched fabric network.

15. The method of claim 14 wherein the fabric interface is one of the group of Infiniband, Star Fabric, and PCI Express.

16. A method of transferring data, the method including imaging data via an imager with a switched fabric interface incorporated therein, and transferring the data to one or more devices connected on the switched fabric network.

17. The method of claim 16 wherein the fabric interface is one of the group of Infiniband, Star Fabric, and PCI Express.
